(19) United States
(12) Patent Application Publication
(10) Pub. No.: US 2024/0116348 A1
(43) Pub. Date: Apr. 11, 2024

(54) VEHICLE FRAME ASSEMBLY

(71) Applicants: HYUNDAI MOTOR COMPANY, Seoul (KR); KIA CORPORATION, Seoul (KR)

(72) Inventors: Seung Min Jeong, Hwaseong-si (KR); Hyo Seop Cha, Seoul (KR)

(73) Assignees: HYUNDAI MOTOR COMPANY, Seoul (KR); KIA CORPORATION, Seoul (KR)

(21) Appl. No.: 18/120,614

(22) Filed: Mar. 13, 2023

(30) Foreign Application Priority Data
Oct. 5, 2022 (KR) 10-2022-0127033

(51) Int. Cl. B60K 1/04

(52) U.S. Cl. CPC B60K 1/04; B60K 2001/0416

(57) ABSTRACT

A vehicle frame assembly includes a battery at a lower portion of a vehicle and a rear floor panel extending in a transverse direction of the vehicle and located rearward of the battery. Opposite ends of the rear floor panel have second rear mounting parts extending outward and a center portion between the second rear mounting parts is depressed downward to provide a boarding space. The vehicle frame assembly includes frame rear side members extending in a longitudinal direction of the vehicle at opposite lateral sides of the battery. Each frame rear side member has a front end and a back end connected to each other to be inclined and each front end has the same height as the boarding space depressed downward, and each back end is coupled to the second rear mounting parts in one direction to support the rear floor panel from below.

### CROSS-REFERENCE TO RELATED APPLICATION

The present application claims priority to Korean Patent Application No. 10-2022-0127033, filed Oct. 5, 2022, the entire contents of which are incorporated herein for all purposes by this reference.

### BACKGROUND

### Field of the Disclosure

The present disclosure relates to a vehicle frame assembly and, more particularly, to a vehicle frame assembly which has a rear frame structure changed to lower a rear floor of a vehicle. The rear frame structure thereby secures the basic durability and stiffness of the vehicle frame assembly and, at the same time, improves the boarding and alighting or exiting performance for passengers.

### Description of the Related Art

Conventionally, in the case of a frame-type truck or van, at a rear part of the vehicle, a height from the ground to a vehicle rear floor is generally designed to be high in order to secure space for a suspension structure of a lower part of the vehicle and a sectional height of a vehicle body side member. Accordingly, since it may result in discomfort or difficulty when a passenger boards a rear space of the vehicle through a rear door of the vehicle, the passenger inevitably boards and alights or exits the vehicle through a second row door on a side portion of the vehicle.

Furthermore, in the case of a commercial cargo truck, since the height from the ground to the rear floor of the vehicle is high, a height of the vehicle is also high. Accordingly, a separate step structure is provided at a rear portion of the cargo truck. However, there may be a problem for passengers boarding the vehicle, which may cause discomfort or even injury to a passenger.

Therefore, the following methods are required. In the case of an existing truck, van, or cargo truck with a step structure, there is discomfort or difficulty when a general passenger or a mobility impaired passenger, i.e., a disabled passenger, boards the vehicle. Thus, a rear floor is lowered to make the passenger's boarding and alighting easier. Furthermore, in the case of a purpose-based vehicle (PBV) that may be used as a hailing service for boarding multiple passengers or as a delivery service, a flat rear floor is provided for accommodating passenger transportation, and delivery of goods and food according to each purpose.

The foregoing is intended merely to aid in understanding the background of the present disclosure. The foregoing is not intended to mean that the present disclosure falls within the purview of the related art that is already known to those having ordinary skill in the art.

### SUMMARY

The present disclosure is intended to provide a vehicle frame assembly configured to have a downward depressed structure of a rear floor of a vehicle to lower the rear floor. The downward depressed rear floor secures the basic durability and stiffness of the vehicle frame assembly and, at the same time, in the case of a delivery vehicle, eliminates the discomfort or difficulty in passengers boarding and alighting or exiting the vehicle and secures or provides an object loading space as much as possible.

In order to achieve the above objects, according to the present disclosure, a vehicle frame assembly is provided. The vehicle frame assembly includes a rear floor panel extending in a transverse direction of a vehicle, located at a rear space of a battery. Opposite ends of the rear floor panel may extend to be bent outward and a center portion of the rear floor panel may be depressed or recessed downward to provide a boarding space. The vehicle frame assembly further includes frame rear side members extending in a longitudinal direction of the vehicle, respectively providing rear ends of opposite frame side members provided at opposite lateral sides of a battery. Each of the rear ends of the frame rear side members may have a front end and a back end that may be connected to each other to be inclined, i.e., with the front end lower than the back end. Additionally, the front end may have a height that is the same height as the boarding space depressed downward and the back end may be coupled to the rear floor panel in one direction to support the rear floor panel from below.

The vehicle frame assembly may include an inner cross member extending in the transverse direction of the vehicle and connecting the front ends of the opposite frame rear side members to each other. The inner cross member may be coupled to the frame rear side members by first rear mounting parts.

The inner cross member may be coupled to the frame rear side members in a vertical bolting manner.

The vehicle frame assembly may include a plurality of inner side members extending in the longitudinal direction of the vehicle and connecting a rear cross member and the inner cross member to each other. The vehicle frame assembly may further include a middle cross member extending in the transverse direction of the vehicle and connecting the plurality of inner side members to each other.

The vehicle frame assembly may include a center floor panel located at a front space of the rear floor panel and an upper space of the battery. The center floor panel and the rear floor panel may be flat structures and be connected to each other in the longitudinal direction of the vehicle.

The vehicle frame assembly may include a rear cross member extending in the transverse direction of the vehicle and connecting the rear ends of the opposite frame rear side members to each other. The rear cross member may be coupled to the frame rear side members by second rear mounting parts.

Cross mounting parts provided at opposite ends of the rear cross member may be respectively coupled to the second rear mounting parts by a vertical bolting manner.

Opposite ends of the rear cross member may extend to be bent outward and a center portion of the rear cross member may be depressed downward to support the rear floor panel from below.

Outer lateral portions of the rear cross member may be respectively coupled to quarter D pillar parts in a sectional coupling manner. Thus, the rear cross member, the rear floor panel, and the frame rear side members may constitute a load path with respect to a vehicle side collision.

The vehicle frame assembly may include spring seats supporting the frame rear side members from below and allowing the frame rear side members to be elastically supported in an upward direction. The vehicle frame assembly may further include shock absorbers that are each connected to the front end and the rear end of each of the frame rear side members and configured to absorb a vertical impact of the vehicle.

The vehicle frame assembly may include a frame cross member extending in the transverse direction of the vehicle and connecting middle portions of the opposite frame rear side members to each other.

The battery may be provided between the opposite frame side members and at a front space of the frame cross member.

The vehicle frame assembly may include a battery rear cross member extending in the transverse direction of the vehicle and supporting the battery from behind.

A middle part of each of the frame rear side members may extend in a diagonally upward direction to connect the front end and the back end thereof to each other so that the front end and the back end may be inclined. An upper surface of the front end and an upper surface of the back end thereof may be formed parallel to each other.

The vehicle frame assembly may include a reinforcement member formed to protrude upward from the rear floor panel and which may have an end that may extend to be bent outward. An upper end surface of the reinforcement member and the rear floor panel may be formed parallel to each other.

According to the vehicle frame assembly of the present disclosure, in order to lower the vehicle rear floor height, the downward depressed structure is applied to the rear floor panel so that the basic durability and stiffness of the vehicle frame assembly can be secured or maintained. Additionally, at the same time, in the case of a delivery vehicle, the discomfort or difficulty in passenger boarding and alighting or exiting is eliminated and an object loading space can be secured or created as much as possible.

The effect of the present disclosure is not limited to the above description. Other effects not mentioned should be clearly understood by those having ordinary skill in the art from the subsequent description.

### BRIEF DESCRIPTION OF THE DRAWINGS

FIG. 1 is a bottom view of a vehicle frame assembly according to an embodiment of the present disclosure.

FIG. 2 is an enlarged view of part of the vehicle frame assembly according to an embodiment of the present disclosure.

FIG. 3 is a view showing a frame rear side member according to an embodiment of the present disclosure.

FIG. 4 is an exterior top and rear perspective view of the part of the vehicle frame assembly according to an embodiment of the present disclosure.

FIG. 5 is a side sectional view of the part of the vehicle frame assembly according to an embodiment of the present disclosure.

FIG. 6 is a rear sectional view of the vehicle frame assembly according to an embodiment of the present disclosure.

FIG. 7 is a view showing a quarter D pillar part coupled to an outside portion of a rear cross member in a sectional coupling manner according to an embodiment of the present disclosure.

FIG. 8 is an exterior rear perspective view showing an arrangement of a seat or a rack according to an embodiment of the present disclosure.

### DETAILED DESCRIPTION OF THE DISCLOSURE

In the following description, the structural or functional description specified to an embodiment according to the concept of the present disclosure is intended to describe the embodiment. Thus, it should be understood that the embodiments of the present disclosure may be variously embodied and modified without being limited to the specific embodiments.

The embodiments described herein may be changed in various ways and various shapes, so a specific embodiment is shown in the drawings and is described in detail in this specification. However, it should be understood that the embodiments according to the concept of the present disclosure is not limited to the embodiments which are described hereinbelow with reference to the accompanying drawings. Nevertheless, all of the modifications, equivalents, and substitutions are included in the scope and spirit of the disclosure.

Unless otherwise defined, all terms including technical and scientific terms used herein have the same meaning as commonly understood by those having ordinary skill in the art to which the present disclosure belongs. It must be understood that the terms defined by the dictionary are consistent with the meanings within the context of the related art. Such terms should not be ideally or excessively formally defined unless the context clearly dictates otherwise.

Hereinbelow, embodiments of the present disclosure are described in detail with reference to accompanying drawings. Like reference numerals given in the drawings indicate like components.

According to an embodiment of the present disclosure, a structure of frame rear side members constituting a part of a vehicle frame assembly is changed to lower a rear floor of a vehicle. Thus, the structure of frame rear side members secures the basic durability and stiffness of the vehicle frame assembly and passenger boarding and alighting performance at the same time.

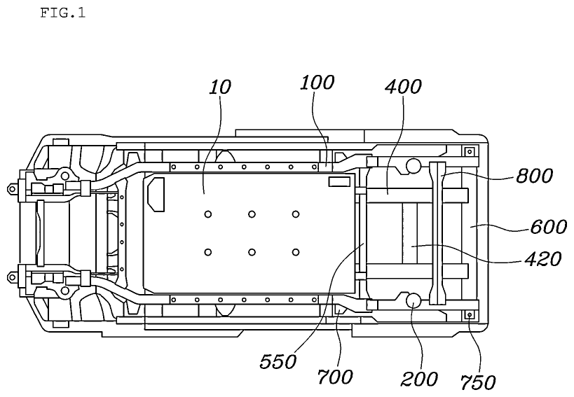

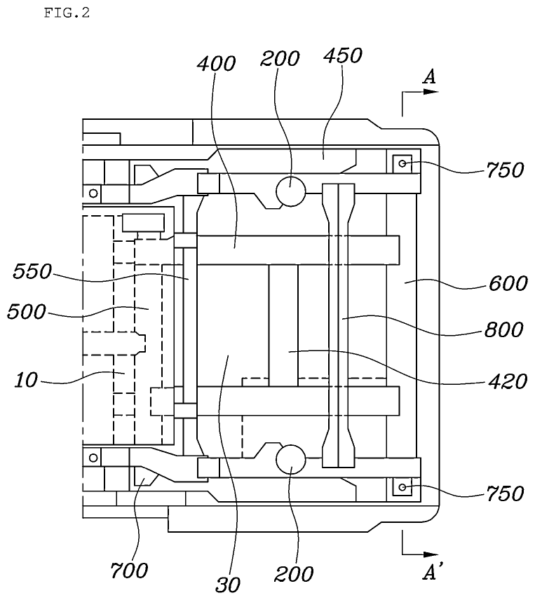

FIG. 1 is a bottom view of a vehicle frame assembly according to an embodiment of the present disclosure. FIG. 2 is an enlarged view of part of the vehicle frame assembly according to an embodiment of the present disclosure.

FIG. 1 shows components relating to an embodiment, and in an implementation on a vehicle, fewer or more components may be included.

Referring to FIGS. 1 and 2, the vehicle frame assembly according to an embodiment may include a battery 10, a rear floor panel 30, frame rear side members 100, spring seats 200, and inner side members 400. The vehicle frame assembly may further include a middle cross member 420, an inner cross member 500, a battery rear cross member 550, a rear cross member 600, first rear mounting parts 700, second rear mounting parts 750, and a frame cross member 800. First, the battery rear cross member 550 extends in a transverse direction of the vehicle and may support the battery 10 from behind. It may be necessary to maximally lower the center of gravity of the vehicle so as to secure or achieve satisfactory driving performance. Therefore, as one of the heaviest components in a vehicle, the high voltage battery may be arranged at a lower surface portion in the vehicle frame assembly so as to secure the stability at an aspect of the center of gravity of the vehicle. Furthermore, a location of the battery is provided at a space between opposite frame side members, which are described below, and at a front space forward of the frame cross member 800. The frame side members and the frame cross member 800 are described below. In the event of an external impact of the vehicle, the battery 10 can be protected by the frame arranged around the battery 10.

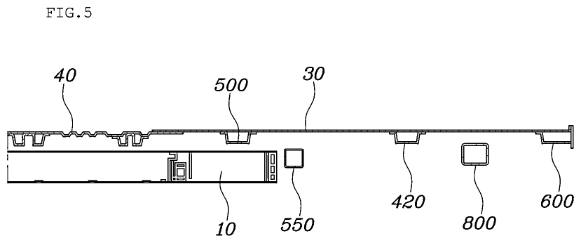

Furthermore, the rear floor panel 30 extends in the transverse direction of the vehicle and may be located at a rear space rearward of or behind the battery 10. Opposite ends of the rear floor panel 30 extend and are bent outward, and a center portion thereof is depressed, i.e., recessed, downward. Thus, the depressed-shape portion serves as a boarding space, simplifies passenger boarding and exiting or alighting, and secures the ability to load objects. A shape of the rear floor panel 30 is described below with reference to FIG. 5, which is a sectional view.

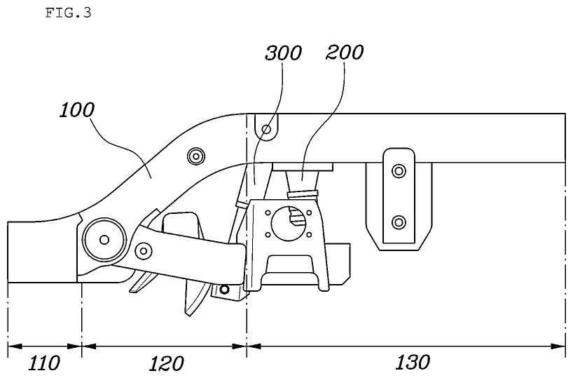

Next, the frame rear side members 100, which are portions of the opposite frame side members mentioned above, extend in a longitudinal direction of the vehicle and may constitute rear ends 20 of the opposite frame side members provided at outside lateral spaces or positions relative to the battery 10. Each of the frame rear side members 100 is divided into a front end 110, a middle portion 120, and a back end 130. The front end 110 and the back end of each of the frame rear side members 100 are connected to each other to be inclined, as shown in FIG. 3. In other words, the front end 110 is positioned at a lower elevation than the back end. The front end 110 has the same height as the boarding space depressed downward, and the back end may be coupled to the rear floor panel 30 in one direction. Therefore, the frame rear side members 100 can support the rear floor panel 30 from below.

FIG. 3 is a view showing the frame rear side members 100 according to an embodiment of the present disclosure.

Referring to FIG. 3, the frame rear side members 100 are a geometric structure of the suspension system of the vehicle. The frame rear side members 100 may have a kick-up shape of which a vertical level difference is formed between a front end 110 and a back end. Furthermore, the frame rear side members 100 may implement the suspension performance of the vehicle with the spring seats 200 and shock absorbers 300.

At this point, the spring seats 200 respectively support the frame rear side members 100 from below and allow the frame rear side members 100 to be elastically supported upward. Each of the shock absorbers 300 is connected to both the front end 110 and the back end of each of the frame rear side members 100 so as to reduce a vertical impact force or load of the vehicle. The shock absorbers 300 may increase the stiffness in response to the reduction of stiffness caused by the vertical level difference of the frame rear side members 100. Additionally, the shock absorbers 300 may increase the ride comfort of passengers. Furthermore, the middle part of each of the frame rear side members 100 extends in a diagonally upward direction so that the front end 110 and the back end may be connected to each other to be inclined as noted above. Furthermore, in each of the frame rear side members 100, an upper surface of the front end 110 and an upper surface of the back end are formed parallel to each other. Thus, the upper surface of the front end 110 may be coupled to the inner cross member 500 by each of the first rear mounting parts 700, and the upper surface of the back end may be coupled to the rear cross member 600 by each of the second rear mounting parts 750.

Prior to the description of the first rear mounting parts 700 and the second rear mounting parts 750, other parts constituting the vehicle frame assembly shown in FIGS. 1 and 2 are described.

First, the inner cross member 500 may extend in the transverse direction of the vehicle and may connect the front ends 110 of the frame rear side members 100 to each other. The inner cross member 500 may be arranged to be located at the front space forward of the battery rear cross member 550 and the upper space of the battery 10. Thus, the arrangement of the inner cross member 500 increases the stiffness of a middle portion 120 of the vehicle frame assembly. The inner cross member 500 is coupled to the frame rear side members 100 at the first rear mounting parts 700, such as by using vertical bolts. Thus, an external impact load or force during passenger boarding and alighting or while loading or unloading an object can be dispersed.

Furthermore, the inner side members 400 may extend in the longitudinal direction of the vehicle and may include a plurality of inner side members 400 arranged symmetrically based on the center portion of the vehicle. The inner side members 400 connect the rear cross member 600, which is described below, to the inner cross member 500. Thus, the basic durability and stiffness of the vehicle frame assembly can be increased. The inner cross member 500 and the frame cross member 800 may extend in the transverse direction of the vehicle and can increase the widthwise stiffness and durability of the vehicle frame assembly. The inner side members 400 may extend in the longitudinal direction of the vehicle and can increase the longitudinal stiffness and durability of the vehicle frame assembly.

Furthermore, the middle cross member 420 may extend in the transverse direction of the vehicle and may connect the plurality of inner side members 400 to each other at a rear portion of the vehicle frame assembly. At a lower space below the middle cross member 420, the frame cross member 800 may extend in the transverse direction of the vehicle and connect the middle parts of the opposite frame rear side members 100 to each other. The frame cross member 800 may be connected to the frame rear side members 100 to increase the basic durability and the durability of the rear portion of the vehicle frame assembly.

FIG. 5 is a side sectional view of the vehicle frame assembly according to an embodiment of the present disclosure.

Referring to FIG. 5, the vertical location relation of the battery 10, the rear floor panel 30, a center floor panel 40, the middle cross member 420, the battery rear cross member 550, the rear cross member 600, and the frame cross member 800 can be seen. The center floor panel 40 may be located at the front space forward of the rear floor panel 30 and the upper space above the battery 10. Additionally, the center floor panel 40 may be supported by the inner cross member 500 located under the center floor panel 40. At this point, the center floor panel 40 and the rear floor panel 30 are horizontally connected to each other in the longitudinal direction of the vehicle and form the flat structure of the vehicle floor together by the respective flat structures thereof. The flat structure of the center floor panel and the rear floor panel 30, as described above, lowers the vehicle floor as much as possible so that the efficiency when passenger boarding and alighting and object being loaded, unloaded, and/or carried can be increased.

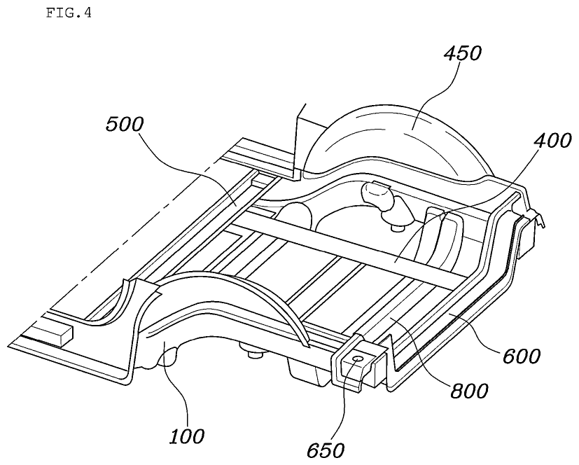

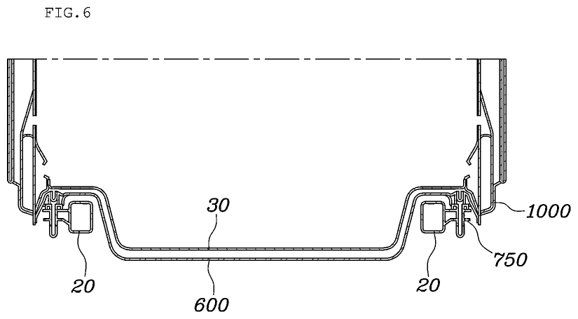

FIG. 4 is an exterior perspective view of the rear part of the vehicle frame assembly according to an embodiment of the present disclosure. Furthermore, FIG. 6 is a rear sectional view of the vehicle frame assembly according to an embodiment of the present disclosure.

Referring to FIG. 4, the rear cross member 600 may extend in the transverse direction of the vehicle and may connect the rear ends of the paced apart frame rear side members 100 to each other. The rear cross member 600 may support the rear floor panel 30 from below. Additionally, the rear cross member 600 includes cross mounting parts 650 at opposite ends thereof. Thus, the rear cross member 600 is coupled to the frame rear side members 100 with an upper surface thereof at the second rear mounting parts 750. The cross mounting parts 650 and the second rear mounting parts 750 form the bolt or attachment coupling structure in a vertical direction so that the vehicle body and a chassis frame can be coupled to each other. Opposite ends of the rear cross member 600 include the cross mounting parts 650 at outwardly extending bent portions, respectively. Furthermore, a center portion of the rear cross member 600 may be depressed or recessed downward and support the rear floor panel 30 from below to increase the stiffness of the vehicle frame assembly.

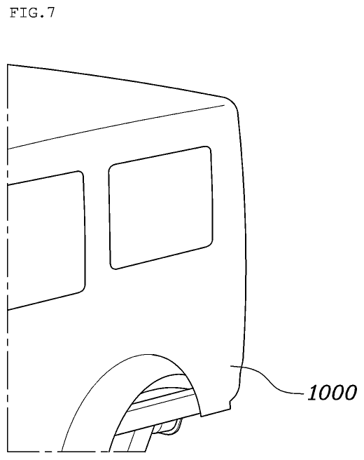

FIG. 7 is a view showing a quarter D pillar part 1000 coupled to an outer lateral portion of the rear cross member 600 in a sectional coupling manner according to an embodiment of the present disclosure.

Referring to FIGS. 6 and 7, the outer lateral portion of the rear cross member 600 is coupled to each of the quarter D pillar parts 1000 in the sectional coupling manner. Thus, the rear cross member 600, the rear floor panel 30, and the frame rear side members 100 can constitute a load path with respect to a side collision of the vehicle. In the event of a side collision of the vehicle, an impact load or force caused by the collision needs to be dispersed from a wheel well inner part 450 to the vehicle frame assembly. To this end, the outer lateral portion of the rear cross member 600 is coupled to the quarter D pillar parts 1000 in the sectional coupling manner. Thus, the impact can be transmitted from the wheel well inner part 450 to the quarter D pillar parts 1000, the rear cross member 600, the rear floor panel 30, and the frame rear side members 100. Therefore, even though each of the frame rear side members 100 has a vertical level difference or change, the one load path is formed with respect to the external impact of the vehicle and the stiffness of the vehicle frame assembly can be secured or achieved.

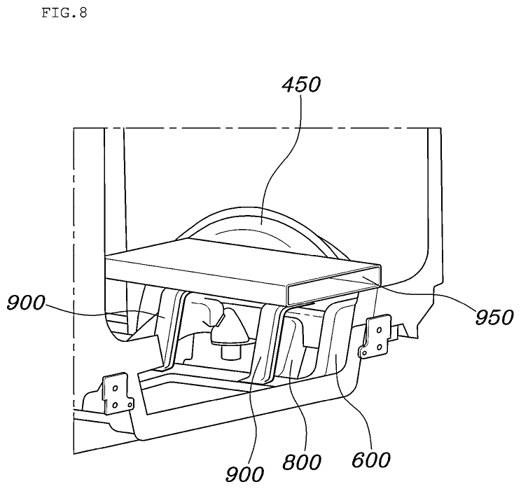

FIG. 8 is an exterior perspective view showing an arrangement of a seat or a rack 950 according to an embodiment of the present disclosure.

Referring to FIG. 8, a seat on which a passenger can sit or a rack capable of loading an object or carrying a loaded object may be arranged at an upper portion of a reinforcement member 900. The reinforcement member 900 may protrude upward from the rear floor panel 30, and an end thereof may extend and be bent outward. Furthermore, an upper end surface of the reinforcement member 900 and the rear floor panel 30 are formed parallel to each other. Thus, at the rear portion of the vehicle, the passenger boarding and alighting performance and the object loading, unloading, and carrying performance by using the rear floor panel 30 can be increased.

Therefore, according to the vehicle frame assembly of the present disclosure, in order to lower the height of a vehicle rear floor, the downward depressed or recessed structure is applied to the rear floor. Thus, the basic durability and stiffness of the vehicle frame assembly can be secured and, at the same time, in the case of a delivery vehicle, discomfort or difficulty of passenger boarding and alighting is eliminated and an object loading space can be increased or secured as much as possible.

Although embodiments of the present disclosure have been disclosed in detail only with respect to the above specific embodiments, those having ordinary skill in the art should appreciate that various modifications, additions, and substitutions are possible, without departing from the spirit and scope of the present disclosure. Therefore, it is appropriate that the various modifications, additions, and substitutions fall within the scope of the accompanying claims.

What is claimed is:

1. A vehicle frame assembly, the vehicle frame assembly comprising:
a rear floor panel extending in a transverse direction of a vehicle, located at a rear space rearward of a battery, wherein opposite ends of the rear floor panel extend and are bent outward and a center portion of the rear floor panel is depressed downward to provide a boarding space; and
frame rear side members extending in a longitudinal direction of the vehicle, respectively providing rear ends of spaced apart frame side members provided at opposite lateral sides of the battery, each of the frame rear side members having a front end and a back end connected to each other with the front end disposed lower than the back end,
wherein the front end has a height that is the same as a height of the boarding space depressed downward and the back end is coupled to the rear floor panel in one direction to support the rear floor panel from below.

2. The vehicle frame assembly of claim 1, further comprising:
an inner cross member extending in the transverse direction of the vehicle, and connecting the front ends of the frame rear side members to each other,
wherein the inner cross member is coupled to the frame rear side members by first rear mounting parts.

3. The vehicle frame assembly of claim 2, wherein the inner cross member is coupled to the frame rear side members in a vertical bolted manner.

4. The vehicle frame assembly of claim 2, further comprising:
a plurality of inner side members extending in the longitudinal direction of the vehicle, and connecting a rear cross member and the inner cross member to each other; and
a middle cross member extending in the transverse direction of the vehicle and connecting the plurality of inner side members to each other.

5. The vehicle frame assembly of claim 1, further comprising:
a center floor panel located at a front space forward of the rear floor panel and an upper space above the battery,
wherein the center floor panel and the rear floor panel have flat structures and are connected to each other in the longitudinal direction of the vehicle.

6. The vehicle frame assembly of claim 1, further comprising:
a rear cross member extending in the transverse direction of the vehicle and connecting the back ends of the frame rear side members to each other,
wherein the rear cross member is coupled to the frame rear side members by second rear mounting parts.

7. The vehicle frame assembly of claim 6, wherein cross mounting parts provided at opposite ends of the rear cross member are respectively coupled to the second rear mounting parts in a vertical bolted manner.

8. The vehicle frame assembly of claim 6, wherein opposite ends of the rear cross member extend are bent outward and a center portion of the rear cross member is depressed downward to support the rear floor panel from below.

9. The vehicle frame assembly of claim 6, wherein outer lateral portions of the rear cross member are respectively coupled to quarter D pillar parts in a sectional coupling manner, so that the rear cross member, the rear floor panel, and the frame rear side members constitute a load path with respect to a vehicle side collision.

10. The vehicle frame assembly of claim 1, further comprising:
spring seats supporting the frame rear side members from below and allowing the frame rear side members to be elastically supported in an upward direction; and
shock absorbers each connected to the front end and the back end of each of the frame rear side members and configured to absorb a vertical impact of the vehicle.

11. The vehicle frame assembly of claim 1, further comprising:
a frame cross member extending in the transverse direction of the vehicle and connecting middle parts of the frame rear side members to each other.

12. The vehicle frame assembly of claim 11, wherein the battery is provided between the opposite frame side members and at a front space forward of the frame cross member.

13. The vehicle frame assembly of claim 12, further comprising:
a battery rear cross member extending in the transverse direction of the vehicle and supporting the battery from behind.

14. The vehicle frame assembly of claim 1, wherein a middle part of each of the frame rear side members extends in a diagonally upward direction to connect the front end and the back end thereof to each other so that the front end is lower than the back end and so that an upper surface of the front end and an upper surface of the rear end thereof are parallel to each other.

15. The vehicle frame assembly of claim 1, further comprising:
a reinforcement member protruding upward from the rear floor panel, and with an end that extends and is bent outward,
wherein an upper end surface of the reinforcement member and the rear floor panel are parallel to each other.
